(19) United States
(12) Patent Application Publication
(10) Pub. No.: US 2002/0078147 A1
(43) Pub. Date: Jun. 20, 2002

(54) Data consultation optimisation method, by means of a network architecture component

(76) Inventors: Nicolas Bouthors, Meylan (FR); Frederic Grardel, St. Egreve (FR)

Correspondence Address: Robert M. Angus, Westman, Champlin & Kelly, International Center, Suite 1600, 900 Second Avenue South, Minneapolis, MN, 55402-3319, US

(21) Appl. No.: 09/965,655

(22) Filed: Sep. 27, 2001

(30) Foreign Application Priority Data
Sep. 29, 2000 (FR) 00 12494

(51) Int. Cl. G06F 15/16

(52) U.S. Cl. 709/203

(57) ABSTRACT

A consultation optimization method for a data page (200), consulted on at least one terminal (100) by at least one user. The page (200) is downloaded from a remote site (103; 104; 105; 106) via a communication network. The method comprising an on-the-fly insertion step (302; 402) of at least one active code (201) enabling the execution of a corresponding algorithm in the page (200) by at least one component (101; 102) of the network architecture.

### FIELD OF THE INVENTION

The invention relates to data consultation on a client terminal, such as a radio-telephone or PC, in particular, said data being sent by a communication network.

More specifically, the invention relates to the optimisation of consultations of sets of data by a plurality of clients, in particular the adaptation of said data to a particular client (user).

### BACKGROUND OF THE INVENTION

The communication network may particularly, but not exclusively, be an Internet type network, such as the world-wide Internet network. In this case, the data is downloaded partly from access links which are destination addresses (or URL addresses, for “Uniform Resource Locator”) to information pages (or Web pages).

In addition, the present invention applies not only when the terminal accesses the communication network directly, but also when it accesses it via at least one other telecommunication network, on which it is registered. Said other telecommunication network is for example the switched telephone network (“fixed network”) and/or a radiocommunication network (“mobile network”).

In the case of a radiocommunication network, said network uses for example the GSM (“Global System for Mobile Communications”) standard, or an equivalent or competing standard such as DCS 1800 (“Digital Cellular at 1800 MHz”), PCS 1900 (“Personal Communication System at 1900 MHz”), DECT (“Digital European Cordless Telecommunications”), GPRS (“General Packet Radio Service”) or UTMS (“Universal Mobile Telecommunication System”).

In order to demonstrate the drawbacks of the prior art in terms of data consultation, a summary of the principles of the current technique to consult data from a Web page, in an Internet network, will now be summarised. Generally, a Web page may be associated either with a site (home page), or a part of a site (other page(s) of the site). Each Web page may also correspond to a service of a site.

It is clear that the drawbacks described below by means of an illustrative example are common to the other data consultation techniques of the prior art.

It is assumed that the client in question accesses a telecommunication network interconnected to the Internet network. Via their terminal (or “network equipment”), they request connection to the Internet network from their access provider, which then provides a communication between the client terminal and the Internet network. After communication is established, the client can access the different Web pages, according to a client-server mode. For this, it is possible to use a client application comprised in the terminal, i.e. a browser, particularly comprising a direct operating mode and an indirect operating mode.

In the direct operating mode, the browser uses the URL addresses known by the user and communicates directly with the browser.

In the indirect operating mode, the browser uses hypertext links (or hyperlinks) contained in another Web page, displayed on the terminal screen. Each hyperlink comprises firstly a URL address and a hypertext (image and/or text) link field contained in the Web page displayed on the terminal screen.

A page's URL address is typically in the following format:

“http://www.mysite.com/mypage.html” where:

“http” identifies the protocol used; and

“www.mysite.com” represents the page's server; and

“mypage.html” characterises the page itself.

After the client has supplied a URL address, directly by input (direct mode) or indirectly by clicking on a hypertext link field corresponding to a Web page of their choice (indirect mode), the browser detects the protocol used (“http”), the server of the page (“www.mysite.com” and the page to be requested (“mypage.html”). Then, it connects to the server and sends it an http (“Hyper Text Transfer Protocol”, used as standard on the Internet network and specified in the standards RFC2616 and RFC2617 published by IETF and available on the site http://www.ietf.org/rfc/) request for the content of the specified page. In both cases, the access link represented by the URL address is said to be activated.

This request is received by the server containing the required Web page (i.e. for which the URL address was given), so that said Web page is sent in return by the server onto the network, via an HTTP (“Hyper Text Transfer Protocol”) connection. Generally, the content of the Web page is described in a page mark-up language, HTML (“Hypertext Mark-up Language, specified in the standards RFC1866 and RFC2854 defined by IETF and available on the site http://www.ietf.org/rfc or in the standard ISO/445 15445 defined by ISO/IEC). This language contains instructions (tags) indicating to the client terminal browser how to organise the Web page when it arrives.

The conventional use of URL addresses, as described above, involves several drawbacks and does not meet all requirements.

First of all, the information is presented according to the specific criteria of the author of the data pages consulted and does not account for the client's needs.

In addition, the conventional use of URL addresses does not automatically enable filtering of relevant data for a client or, on the other hand, to censor certain data.

Moreover, the conventional use of URL addresses does not enable permanent provision of a Web service irrespective of the site accessed.

The conventional use of URL addresses also does not enable the insertion of advertising in Web pages when accessed.

The invention particularly aims to make up for the various drawbacks of the state of the art.

More precisely, one of the aims of the present invention is to provide a technique to consult data present on a communication network, enriched and adapted to each (or at least certain) client(s).

Another aim of the invention is to provide a client with data selected for said client according to their needs, choices, instructions, etc.

The invention also aims to take the data consulted into account to offer relevant additional data on the fly.

The invention also aims to provide such a technique which is simple to implement and inexpensive.

Another aim of the invention is to provide such a technique, including one alternative embodiment which does not require any modification of the client terminals.

A further aim of the invention is to enable an operator or Internet site manager to provide a high added value service.

Another aim of the invention is to enable the permanent provision of an Internet service, irrespective of the site accessed.

The invention also aims to enable the insertion of targeted additional data, particularly advertising, in Internet pages during access.

### SUMMARY OF THE INVENTION

These various aims, and others subsequently described, are achieved according to the invention using a method to optimise the consultation of a data page consulted on at least one terminal by at least one user, the page being downloaded from a first remote site, via a communication network, characterised in that it comprises an on-the-fly insertion step of at least one active code in the page by at least one component of the network architecture.

Note that an active code is a code enabling the execution of an algorithm and/or instructions by the user terminal.

In this way, the invention has applications which particularly enrich the content provided by the first remote site by particularly providing it with additional information or services, generally without penalising the access time to the remote site.

According to a particular characteristic, the consultation optimisation method is characterised in that the communication network is an Internet type network.

An Internet type network is to be taken in the broad sense of the term and covers all the data networks operating with mark-up languages such as HTML (HyperText Mark-up Language), XML (eXtensible Mark-up Language), WML (Wireless Mark-up Language).

According to a particular characteristic, the consultation optimisation method is characterised in that at least one component of the network architecture belongs to the group comprising:

Internet site host servers;

access provider equipment;

service provider equipment;

routers;

switches;

gateways; and

proxies.

In this way, it is possible to benefit advantageously from all the possibilities of an Internet type network, the data exchanged between a remote site and a terminal transiting generally via various network components which can easily insert one or more active codes on the fly.

It is important to note that access or service providers are particularly well positioned to insert active code on the fly in data transiting via their equipment and reach a large number of potential users.

According to a particular characteristic, the consultation optimisation method is characterised in that the area of the page wherein the active code is inserted is determined according to the type of action generated by the active code.

In this way, the insertion of an active code in a specific area of a data page may particularly be well suited to certain applications:

the insertion of active code at the start of a page is, for example, well-suited for applications to block certain types of data or restrict access to URLs present in the data;

the insertion of active code at the end of the page is, for example, well-suited for targeted advertising type applications.

According to a particular characteristic, the consultation optimisation method is characterised in that the active code inserted on the fly is a final active code enabling the running of an algorithm on the terminal.

According to a particular characteristic, the consultation optimisation method is characterised in that the active code inserted on the fly is an intermediate invocation active code, which, when run by the terminal, enables the terminal to invoke a final active code provider, so that the terminal receives from said provider a specific final active code used to run an algorithm on the terminal.

In this way, the invention advantageously makes it possible to take into account two different types of active codes:

active code running a final algorithm directly on the terminal; or

intermediate active code invoking a final active code which will be run on the terminal.

These two types of active code are of interest. The active code run directly on the terminal can be processed directly by the terminal while the intermediate active code can particularly be customised more easily than a directly run active code.

According to a particular characteristic, the consultation optimisation method is characterised in that, when the final active code provider is invoked by the terminal, the terminal also provides at least one cookie.

A “cookie” is an Internet mechanism which enables site developers to place information on the terminal for subsequent use. A cookie particularly consists of a memory or storage unit used to store the information in hexadecimal format. A browser running on a terminal stores the cookies given to it by a site and keeps them at the disposal of script codes included in the pages of said site, or sends them to the site's Web server at the same time as the content request when the requested page is the result of an executable.

In this way, the cookie delivered may advantageously be used by an active code sent by the site which delivered the cookie or by said site to deliver a customised active code.

According to a particular characteristic, the consultation optimisation method is characterised in that it also comprises at least one step prior to the on-the-fly insertion step and belonging to the group comprising:

steps consisting of rerouting a terminal access to the final active code provider;

steps consisting of defining a terminal user profile;

cookie generation steps as a function of the terminal user profile;

steps consisting of provision of the cookie by the final active code provider to the terminal; and

steps consisting of storage of said at least one cookie by the terminal.

According to a particular characteristic, the consultation optimisation method is characterised in that the cookie is used for identification purposes.

According to a particular characteristic, the consultation optimisation method is characterised in that the final active code provider accounts for the content of said at least one cookie to generate the specific final active code.

In this way, advantageously, the invention enables a user to define a profile during a prior access to the final active code provider, with said profile possibly particularly containing user identification information, information indicating their preferences (information of particular interest or undesired information, information presentation mode, etc.). As said profile is stored in the form of a cookie attached to the final active code provider, the final script may either use the information from the cookie on the terminal, or be generated as a function of said information after the delivery of the cookie to the final active code provider.

According to a particular characteristic, the consultation optimisation method is characterised in that the active code belongs to the group comprising:

script codes interpreted by a browser;

script code includes interpreted by a browser;

browser objects;

browser object operations;

applets;

applet operations; and

macro-instructions.

In this way, the invention takes into account the numerous existing variants of active code, in particular:

script codes, which are instruction sequences, particularly used to handle, customise and automate certain tasks offered by the terminal; there are several languages used to write script codes (the specifications of an example of script language are available in the document “ECMAScript Language Specification” published by ECMA and available at the site http://www.ecma.ch. There are other script languages, particularly the languages JavaScript® developed by Netscape® company and Jscript® developed by Microsoft® company);

script code “includes” (or external script codes) which characterise the script code inclusion instructions, supported by the language used during exchanges. (The term “include” is a term used in languages supporting script codes);

browser objects such as ActiveX®, in particular, which are browser objects added dynamically in the operating systems developed by Microsoft® company, such as Windows®;

browser object operations which indirectly invoke at least one browser object function;

applets which are small applications developed in Java language invoked by an Internet page, downloaded and run by the terminal, which control resource access;

applet operations which indirectly invoke at least one or more applet functions;

macro-instructions which are instruction sequences which may be used particularly in applications running on the terminal such as word processing, image or spreadsheet applications, for example.

The invention makes it possible advantageously to make the most of the terminal according to the target application.

According to a particular characteristic, the consultation optimisation method is characterised in that the active code inserted in the page is loaded and/or interpreted and/or run by the terminal before, during and/or after the display of the page on the terminal.

In this way, depending on the type of application, the active code will advantageously be run before, during and/or after the display of the page, particularly according to the type of application.

According to a particular characteristic, the consultation optimisation method is characterised in that the active code is run in a browser comprised in the terminal.

According to a particular characteristic, the consultation optimisation method is characterised in that the active code is generated specifically as a function of at least one criterion specific to a component belonging to the group comprising:

the terminal user(s);

the terminal;

the first remote site;

the page;

the network architecture components; and

the browser used by the terminal.

According to a particular characteristic, the consultation optimisation method is characterised in that the criterion belongs to the group comprising:

the identity of the terminal user;

the preferences of the terminal user;

the address and/or domain name of the first remote site;

the address of the downloaded page;

the browser type and/or version used by the terminal;

the terminal type and/or version;

the transfer protocol used to download the downloaded page; and

the Internet access or service provider enabling the terminal to access the first remote site.

In this way, the invention makes it possible advantageously to customise the active codes as a function of very different criteria which may particularly comprise the following criteria:

The user and their identifiable preferences, particularly by means of cookies;

the addresses of the downloaded page and the site, particularly the URL addresses (Uniform Resource Locator), which clearly specify the physical location of the page and site;

the browser type and version which is direct information sent by the browser;

the terminal type and version which is indirect information sent by the browser;

the transfer protocol which may be in particular, HTTP, FTP, POP, IMAP, RSTP; and

the Internet service or access provider (or ISP/IAP) which is identifiable by its addressing range.

According to a particular characteristic, the consultation optimisation method is characterised in that it is used for at least one application belonging to the group:

insertion, in the page, of information, particularly advertising;

insertion, in the page, of information, particularly advertising, as a function of page content;

insertion, in the page, of information relating to events handled by a second remote site connected to the network;

insertion, in the page, of information relating to data available on a portal in relation to the page content;

provision to the user, via the page, of at least one service provided by at least one third remote site connected to the network;

archival of information related to the activity on the network of the terminal user;

modification of data presentation;

censoring of at least one data item in the data; and

invocation of at least one second active code.

In this way, the invention advantageously makes it possible to implement numerous applications which are not handled directly by the first remote site.

According to a particular characteristic, the consultation optimisation method is characterised in that it is used for at least one application for the insertion in the page of additional information,

and in that the active code implements the following operations:

search for at least one specific information item in the page;

creation of a list of specific information found in the page;

creation of an additional information insertion field in the page;

provision of the list of specific information to a provider of additional information connected to the network; and

filling of the additional information insertion field with the data provided by the information provider in response to the specific information list provision operation.

According to a particular characteristic, the consultation optimisation method is characterised in that the additional information belongs to the group comprising:

advertising information;

annotations;

additional links to remote sites discussing the same subject as the downloaded page;

additional links to remote sites discussing subjects related to the subject of the downloaded page;

alternative key-words;

notes assigned to the first remote site; and

indexing tables for the components of the downloaded page.

In this way, the invention advantageously makes it possible to add information, particularly annotations, which may provide a high added value if they are, for example, sent by parties independent of the first site, and/or alternative key-words (particularly synonyms or associations, used for example to run an appropriate and/or precise search on the Internet) and/or indexing tables enabling quick access to the page.

According to a particular characteristic, the consultation optimisation method is characterised in that it is used for at least one data presentation modification application;

and in that the active code implements the following operations:

search for at least one specific information item in the page;

creation of a list of specific information found in the page;

provision of the list of specific information to a provider of additional information connected to the network;

presentation of at least one part of the downloaded data according to a format defined by the information provider in response to the specific information list provision operation.

In this way, the invention advantageously makes it possible not only to enrich the content of the data but also enrich the format by redefining, if applicable, the format of said data to highlight certain parts or, on the other hand, reduce their visibility as a function of any criteria.

According to a particular characteristic, the consultation optimisation method is characterised in that it is used for at least one application to censor at least one data item in the data,

and in that the active code implements the following operations:

search for at least one specific information item in the page;

creation of a list of specific information found in the page;

provision of the list of specific information to a provider of additional information connected to the network;

censoring of at least one part of the downloaded data according to at least one criterion defined by the information provider in response to the specific information list provision operation.

In this way, the invention advantageously makes it possible to prevent the display of certain data items, particularly because they are not desired by the user or not authorised for the user according to their profile.

According to a particular characteristic, the consultation optimisation method is characterised in that it is used for at least one application to invoke at least one second active code,

and in that the active code implements the following operations:

search for at least one specific information item in the page;

creation of a list of specific information found in the page;

provision of the list of specific information to a provider of additional information connected to the network;

invocation of at least one second active code according to at least one criterion defined by the information provider in response to the specific information list provision operation.

In this way, the invention advantageously makes it possible to provide a second active code customised as a function of the data in particular.

According to a particular characteristic, the consultation optimisation method is characterised in that the specific information belongs to the information group comprising:

key-words;

link addresses;

addresses of related components in the downloaded page; and

downloaded page creation information.

In this way, the active code depends advantageously on the components related to the data, particularly the related components in the downloaded page which are for example images and/or page creation information which particularly consists of its author, the creation date and the company to which the author belongs.

According to a particular characteristic, the consultation optimisation method is characterised in that the specific information is updated according to a predetermined criterion.

According to a particular characteristic, the active code insertion method is characterised in that the predetermined criterion belongs to a group of criteria comprising:

the identity of the terminal user;

the preferences of the terminal user;

the address and/or domain name of the first remote site;

the address of the downloaded page;

the browser type and/or version used by the terminal;

the terminal type and/or version;

the transfer protocol used to download the downloaded page; and

the Internet access or service provider enabling the terminal to access the first remote site.

In this way, the active code depends advantageously not only on the data-related components, but also components related to the terminal, its user or the Internet access provider.

According to a particular characteristic, the active code insertion method is characterised in that it is used for at least one application for permanent provision to the user, via the page, of at least one service provided by at least one fourth remote site connected to the network, and in that the active code, when it is run by the terminal, declares the service in the page.

The declaration of the service in the page means that the active code renders the service accessible when the page is downloaded on the terminal by associating it with an event, for example.

According to a particular characteristic, the active code insertion method is characterised in that the code enables the implementation by the terminal of a service access menu.

According to a particular characteristic, the active code insertion method is characterised in that the service belongs to the group comprising:

simplified access services to information other than that contained in the page;

simplified access services to search engines;

simplified access services to advanced functions of a browser comprised in the terminal;

external event monitoring services; and

simplified access to at least one service available manually on the Internet and which requires at least one data input operation.

In this way, in an advantageous embodiment of the invention, the on-the-fly insertion of active code enables simplified access to services related to:

the detection and processing of a selection (selection of a word, group of words, image, link, etc.) by a mouse connected to the terminal; and/or

the service activation simplicity (popup menu or double-click).

On-the-fly active code insertion also makes it possible to access services available manually on the Internet and which requires at least one data input operation (particularly words, phrases, URL addresses), such as for example:

search for Web content (site engine in the common sense of the term);

search for price or service on the Web (price comparison engine, professional reference library, etc.);

search for meanings (encyclopaedias); and

multilingual translation (dictionaries, machine translation of phrases).

The concept of “external event monitoring” is comparable to the customisation of the active code returned by an active code server. Indeed, it is possible to return a code generating an alert message whenever an event is to be sent to the identified user (by cookie) (for example, an external event may be the arrival of e-mail to the user's e-mail account on a portal, while they are browsing on a site other than the portal).

Monitoring of external events particularly makes it possible to return a code generating a warning message whenever an event is to be sent to the identified user (by cookie).

According to a particular characteristic, the active code insertion method is characterised in that the service is attached to at least one event belonging to the group comprising:

actions on a man-machine interface; and

browsing events.

In this way, advantageously, an active code may be associated with actions on a mouse controlling the terminal (particularly right-clicking (resulting in popup menu display), double-clicking, moving a pointer controlled by the mouse in or outside the screen zone), actions on one or more keyboard keys, combined actions on the mouse and at least one keyboard key (particularly sequences and synchronisation of several actions on the mouse and at least one keyboard key), actions on a sensitive screen, or voice control.

Icons are of particular interest for mobile terminals, with small screens.

In addition, browsing events will particularly consist of the start and end of page loading, page exits, loading errors, interpretation errors, execution errors.

According to a particular characteristic, the active code insertion method is characterised in that the service is attached to at least one mark-up language component.

The mark-up languages in question particularly consist of HTML (HyperText Mark-up Language), XML extensible Mark-up Language), WML (Wireless Mark-up Language).

Mark-up language components particularly consist of a menu bar which may be pull-down type or superimposed icons on the terminal screen.

According to a particular characteristic, the active code insertion method is characterised in that the on-the-fly insertion step is systematic or selective.

The on-the-fly insertion may be selective for example as a function of the URL address of the remote site.

According to a particular characteristic, the active code insertion method is characterised in that the execution of the active code is interrupted when the user requests the display of a new data page.

According to a particular characteristic, the active code insertion method is characterised in that, when the data page is composed of at least two sub-pages, the active code is included in each sub-page.

The invention also relates to a system characterised in that it comprises means suitable for the implementation of the active code insertion method described above.

The invention also relates to a device to insert at least one active code in a data page, consulted on at least one terminal by at least one user, the page being downloaded from a first remote site, via a communication network to which the device belongs, characterised in that it comprises means to insert active code on the fly in the page.

According a particular characteristic, the device to insert at least one active code is characterised in that it belongs to the group comprising:

Internet site host servers;

access provider equipment;

service provider equipment;

routers;

switches;

gateways; and

proxies.

The particular characteristics and advantages of the on-the-fly active code insertion devices and system being the same as those for the on-the-fly active code insertion method, they will not be repeated here.

### BRIEF DESCRIPTION OF THE DRAWINGS

The invention's other characteristics and advantages will be seen upon reading the following description of a preferential embodiment of the invention, given as a non-restrictive example, and the appended figures, wherein:

FIG. 1 schematically illustrates a network, according to a particular embodiment of the invention;

FIG. 2 describes a source code page, according to a particular embodiment of the invention;

FIG. 3 shows a communication protocol with insertion of a script in a data page by an Internet service provider, according to a particular embodiment of the invention;

FIG. 4 shows a communication protocol with insertion of an “include” of script code in a data page by an Internet service provider, according to a particular embodiment of the invention;

FIG. 5 shows a communication protocol with insertion of an “include” of script code for an advertising insertion type application, according to a particular embodiment of the invention;

FIG. 6 shows a communication protocol with insertion of an “include” of script code for a permanent Internet service provision type application, according to a particular embodiment of the invention.

### DETAILED DESCRIPTION OF THE PREFERRED EMBODIMENTS

The general principle of the invention is based on the insertion of active code on the fly by a component of a network infrastructure in data downloaded onto a terminal (such as a micro computer or radio-telephone, a wireless or mobile terminal, particularly GSM, GPRS or UMTS type) from the network.

The network is particularly an Internet type network; a component of an infrastructure of such a network is for example an item of Internet site equipment, a router, a switch, a gateway, a proxy or a combination of at least two of these types of equipment.

The downloaded data is generally specified in a mark-up language such as the languages HTML, XML, WML.

When the terminal receives the downloaded data, it runs the specified instructions including the active code sequentially.

Said active code may take several forms depending on, in particular, the type of application:

script codes interpreted by a browser;

script code “includes” interpreted by a browser;

browser objects;

browser object operations;

applets;

applet operations; and

macro-instructions.

The active code may be considered as final or intermediate:

when the active code is a final code, it does not require a script server when being run on the terminal;

when the inserted active code is an intermediate invocation active code, when it is run by the terminal, it enables the terminal to invoke a final active code particularly on a script server, so that the terminal can receive a final specific active code from said server enabling the execution of an algorithm on the terminal. In this case, the final active code may use a cookie linked to the script server and already present on the terminal by processing the information provided by said cookie.

As a general rule, one or more cookies may be supplied to the terminal when the script code server is first accessed.

Following this, following a content request, an intermediate invocation active code will be inserted on the fly in the content. Said active code will trigger a script code request to the script code server, the cookie(s) being supplied to the script code server at the same time as the request. The script server analyses the cookie(s) received, composes a script code as a function of the cookie(s) received and sends the composed script code, which is thus adapted or even customised to the terminal user, to the terminal.

The major applications of on-the-fly active code insertion include:

the insertion of customised annotations in data pages consulted on a terminal; (it will particularly be possible to use the method as described in the patent application entitled “data consultation method and system” registered on the same day as the present application by the same applicant. The text of said application in inserted here for reference purposes.)

the insertion of targeted additional data, particularly advertising, in data pages consulted on the terminal;

the provision of easy-access services for the user enabling them in particular to access (particularly by simply clicking on the mouse or pressing function keys on the terminal keyboard) a specific remote site.

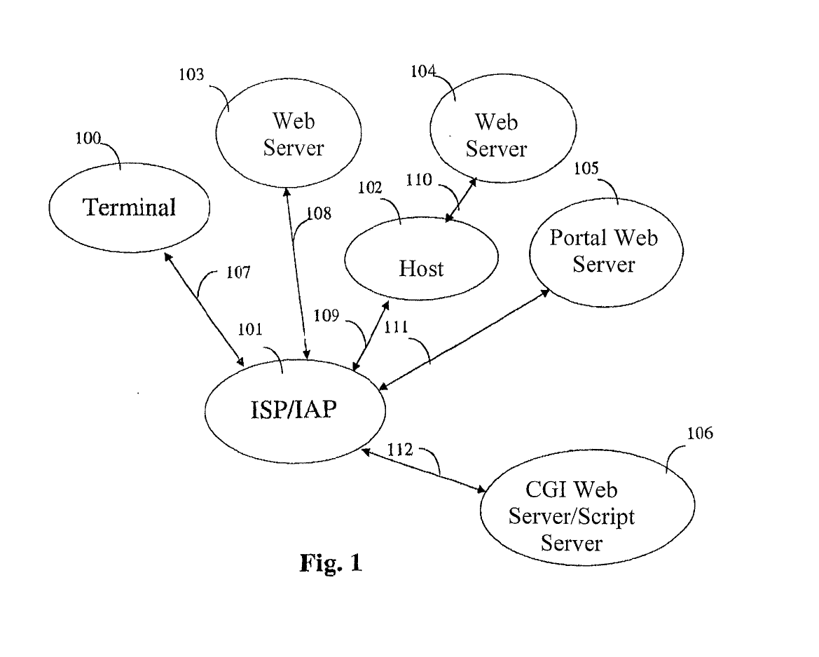

FIG. 1 shows a telecommunication network infrastructure enabling the implementation of a preferential embodiment of the invention.

Said infrastructure particularly comprises:

one client terminal 100;

one item of Internet Service Provider (ISP) or Access Service Provider (ASP) equipment 101;

one item of Internet site host equipment 102;

two Web site servers 103 and 104;

one Web site server 105 acting as a portal; and

one Web site server 106 acting as a script server or CGI (“Common Gateway Interface”, the specifications of which are described on the site http://hoohoo.ncsa.uiuc.edu/cgi/).

The client terminal 100 is of any type such as a computer and/or mobile terminal.

The client terminal 100 can access an item of Internet Service Provider (ISP) or Access Service Provider (ASP) equipment 101 via a link 107, enabling it to download data, in particular.

The Internet Service Provider (ISP) or Internet Access Provider (IAP) equipment 101 is linked to the Web servers 103, 105 and 106 via the links 108, 111 and 112, respectively.

The Internet Service Provider (ISP) or Access Service Provider (ASP) equipment 101 is also linked to the Internet site host equipment 102 via a link 109.

The links 107, 108, 109, 110 and 112 are any communication links, particularly links belonging to a switched telephone network (STN), Internet type links and/or links belonging to a radiocommunication network (for example, using the GSM or another standard).

In this way, the terminal 100 can access the content of sites handled by any of the servers 103, 104, 105 or 106.

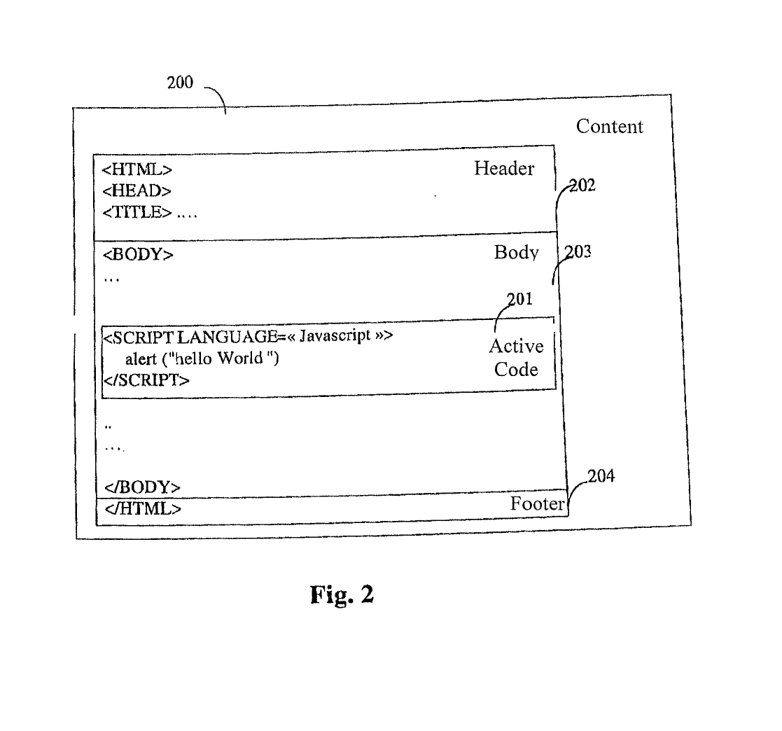

FIG. 2 schematically illustrates a source code page 200 as presented to the terminal 100 after insertion of an active code in a data page supplied by a content server such as any of the servers 103, 104, 105 or 106.

Note that the content page 200 is a content page which is divided into three parts:

a header 202 particularly containing instructions used to identify the language used (in this case, HTML, for example) and a page title.

a body 203 particularly containing information and an active code 201

a footer 204 particularly containing an HTML page footer instruction.

In the preferential embodiment, the active code is a Javascript code which starts with a tag indicating the start of a script and its type (“<SCRIPT LANGUAGE=“Javascript”>”), which is followed with one or more specific instructions which will be run on the terminal 100 (for example, opening of an alert window containing a message “hello world” with the instruction alert(“hello world”)) and ends with a tag indicating the end of the script code (“</SCRIPT>”).

Note that a script code particularly contains:

one or more instructions which are interpreted and run sequentially; and if applicable

one or more functions that can be called up when the script code is run or following an event handled by an application such as a browser.

In a first alternative, the script code is not placed in the body 203 of the content 200 but in its header 202, or in the footer 204. It may also be placed outside the HTML fields while remaining in the content 200 supplied to the terminal 100.

In a second alternative, several active codes corresponding to the same application or not are inserted in the content 200.

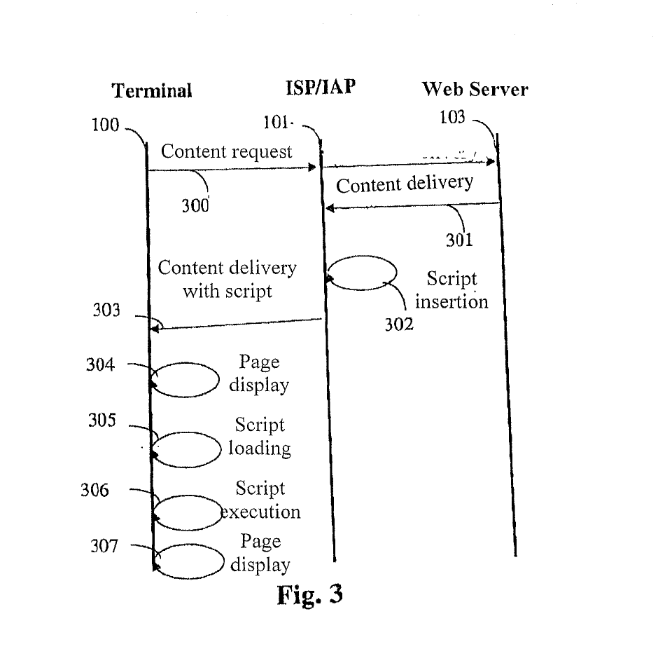

FIG. 3 shows a communication protocol with insertion of a script in a data page by an Internet service provider 101.

Following a consultation 300 by the terminal 100 of the Web site server 103 site via the access provider 101, the server 103 delivers content to the access provider 101 during a content delivery step 301.

Then, during a script insertion step 302, the access provider inserts a script 201 as described with respect to FIG. 2, in the delivered content.

In an alternative of the script insertion step 302, the access provider inserts the script 201 according to a predetermined criterion such as, for example, the address of the server 103.

According to another alternative of the step 302, when the content 200 is divided into sub-pages, the access provider inserts the script 201 in each sub-page.

Following this, during a content delivery with script step 303, the access provider 101 delivers a content 200 as described with respect to FIG. 2 containing the inserted script code 201, to the terminal 100.

Then, the terminal 100 runs the instructions present in the content 200 received sequentially.

In this way, during a page start display step 304, the terminal 100 starts by running the first instructions of the content particularly the instructions present in the header 202 and in the start of the body 203.

Then, during a step 305, the terminal 100 loads the script 201 in memory.

Following this, during a step 306, the terminal 100 interprets the script 201 (script interpretation consists of converting the script which is written in a high-level language not directly comprehensible by the terminal 100 into elementary actions without using a machine code) and runs it to open an alert window and display a message, for example.

According to an alternative of the step 306, the interpretation and execution of the script code are interrupted when the user requests the display of a data page.

According to a first alternative described with respect to FIG. 2, the script code is not placed in the body 203 of the content 200 but in its header 202, or in the footer 204. It may also be placed outside the HTML fields while remaining in the content 200 supplied to the terminal 100.

When the script code is placed in the header 202, or before the HTML field, the script interpretation 305 and execution 306 steps take place before the page start display step 304 (in this case, combined with the page end display step 307).

A direct application of the first alternative is a Web page censoring type application. According to this application, the script code is placed in the header 202, or before the HTML field, and is used to censor all or part of the data following the script code in the content. It will be particularly possible to censor data (i.e. not display it on the terminal 100 and/or render it unavailable) if the user of the terminal 100 does not have the authorisation required to access said data.

When the script code is placed in the footer 204, or after the HTML field, the script interpretation 305 and execution 306 steps take place after the page end display step 304 (in this case, combined with the page start display step 304).

In this way, another direct application of the first alternative is an application to insert annotations or additional information (such as advertising information, in particular) particularly displayed after data at the end of the display of said data.

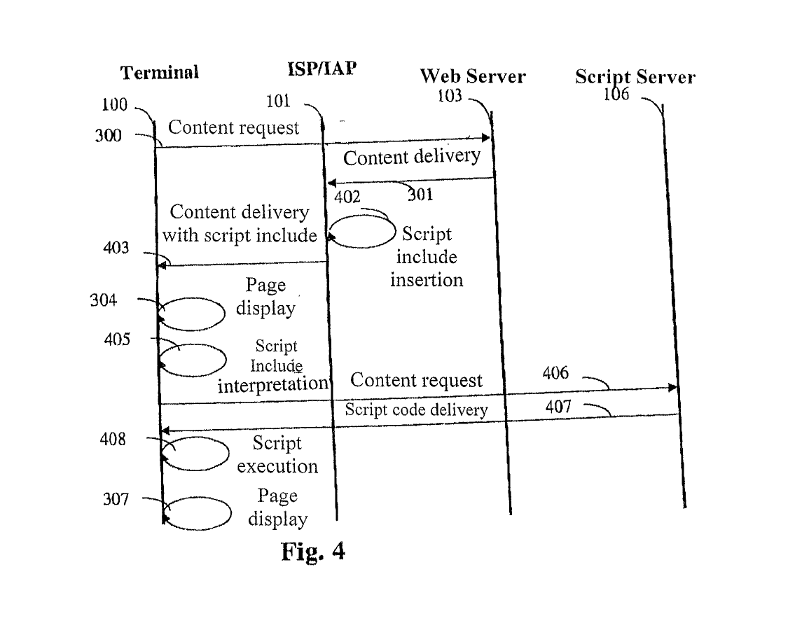

FIG. 4 shows an alternative of the communication protocol with insertion of a script code “include” in a data page by an Internet service provider 101.

Following the consultation 300 by the terminal 100 of the server 103 site via the access provider 101, the server 103 delivers content to the access provider 101 during a content delivery step 301.

Then, during a script code “include” insertion step 402, the access provider 101 inserts a script code “include” type active code.

The script code “include” is inserted in a similar manner to that for a script code 201 in a content 200.

In an alternative of the step 402, the access provider inserts the script code “include” 201 according to a predetermined criterion such as, for example, the address of the server 103.

According to another alternative of the step 402, when the content 200 is divided into sub-pages, the access provider inserts the script code “include” 201 in each sub-page.

Following this, during a content with script “include” delivery step 403, the access provider 101 delivers a content 200 containing the inserted script code “include”.

Then, the terminal 100 runs the instructions present in the content 200 received sequentially.

In this way, during a page start display step 304, the terminal 100 starts by running the first instructions of the content particularly the instructions present in the header 202 and in the start of the body 203.

Then, during a step 405, the terminal 100 interprets the script code “include” by decoding the instructions present in the script code “include”.

Following this, during a content request step 406 generated by the interpretation of the script code “include”, the terminal 100 requests a content from a script server at a URL address stipulated by the script code “include” and corresponding to the script server 106.

In this way, if for example the script “include” is as follows:

<script src=http://www.mysite.com/myscript.js></script>

the terminal 100 requests the script “myscriptjs” from the script server “www.mysite.com”.

According to an alternative of the step 406, the script code “include” is interrupted when the user requests the display of a new data page.

Then, during a step 407, the script server 106 delivers a script code “myscript.js” in our example) to the terminal 100.

Following this, during a step 408, the terminal 100 writes in its memory the content of the script (in this case, “myscript.js”) returned by the script server, interprets and runs it. The execution of the script code received consists, for example, of opening an alert window containing a message.

Then, during a step 307, the terminal runs the instructions following the script code “include” in the content 202 delivered, particularly the instructions in the end of the body 203 and in the content footer 204.

According to a first alternative described with respect to FIG. 2, the script code is not placed in the body 203 of the content 200 but in its header 202, or in the footer 204. It may also be placed outside the HTML fields while remaining in the content supplied to the terminal 100.

When the script code “include” is placed in the header 202, or before the HTML field, the script “include” interpretation step 405, content request step 406, script code delivery step 407 and script code interpretation and execution steps 408 take place before the page start display step 304 (in this case, combined with the page end display step 307).

A direct application of the first alternative is a Web page censoring type application, very similar to the censoring type application described with respect to FIG. 3.

When the script code “include” is placed in the footer 204, or after the HTML field, the script “include” interpretation step 405, content request step 406, script code delivery step 407 and script code interpretation and execution steps 408 take place after the page end display step 307 (in this case, combined with the page start display step 304).

Another direct application of the first alternative is an application to insert annotations or additional information (such as advertising information, in particular) displayed after data at the end of the display of said data, very similar to that described with respect to FIG. 3.

Note, therefore, that FIGS. 3 and 4 describe two complementary embodiments of the invention: in FIG. 3, the access provider inserts a script code directly in the data while, in FIG. 4, the access provider inserts a script code “include” which will be used by the terminal to request a content in turn containing a script code.

Following this, two applications are described. According to a preferential embodiment these two applications are based on the alternative of the protocol described with respect to FIG. 4 but they can also be implemented according to the preferential embodiment described with respect to FIG. 3.

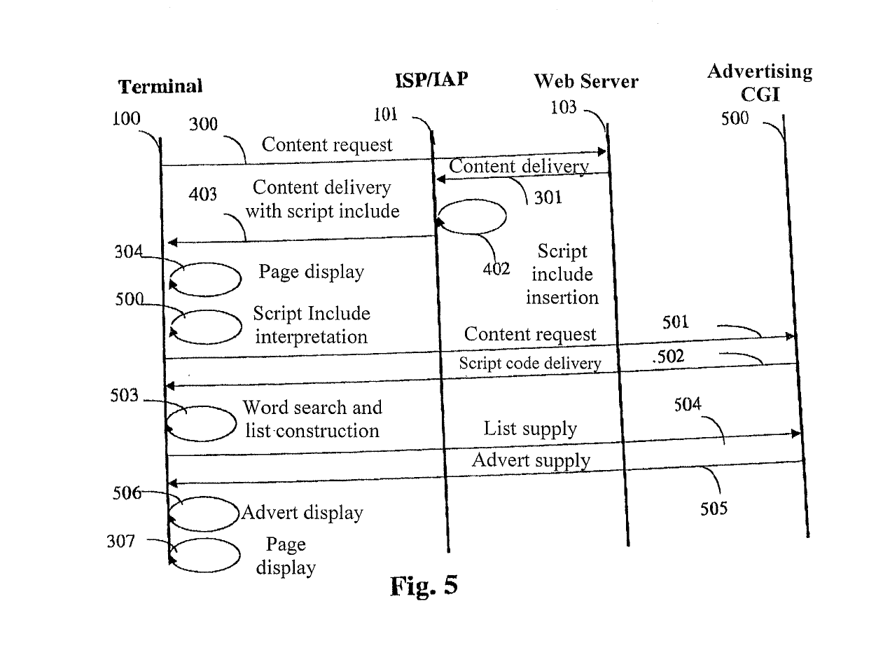

FIG. 5 shows a communication protocol for an advertising insertion type application wherein the first steps 300, 301, 402, 403 and 304 are identical to the first steps of the protocol described with respect to FIG. 4, apart from the fact that during the script code “include” insertion step 402, the access provider 101 inserts a particular script code “include” wherein the final purpose is to deliver additional information, particularly advertising. The first steps of FIG. 5 being similar to the first steps of FIG. 4, they bear the same reference numbers and will not be described further.

Following the page start display step 304, during a received script code “include” interpretation step 500, the terminal 100 interprets said “include” by decoding the instructions present in the script code “include”.

Then, during a content request step 501, the terminal requests a content from a server wherein the URL address has been specified by the script code “include” received, in this case, for example, the address of the advertising CGI type server 500.

Following this, during a step 502, the server 500 delivers the specified content to the terminal 100. Said content particularly contains an active code enabling the semantic search particularly using key-words in the data displayed on the screen of the terminal 100. In this case, said active code is a script code. However, alternatively, said active code may take all the forms of active code described with respect to the description of the general principle of the invention.

Then, during a semantic search step 503, the terminal 100 runs the active code. This execution consists of a search for specific information present in the page displayed on the screen and the construction of a list of specific information found: the specific information particularly consists of key-words, link addresses, addresses of added items in the downloaded pages and creation information on the downloaded pages such as its author, the creation date and the company to which its author belongs. The searched specific information is updated according to a predetermined criterion and particularly depends on one or more criteria, including, in particular, the identity of the user of the terminal 100, their preferences, the address and/or domain name of the remote site that supplied the content 200, the browser type and/or version used by the terminal 100, the type and/or version of the terminal 100, the transfer protocol used to download the downloaded content 200 and the access provided enabling the terminal 100 to access the content sites.

Following this, during a step 504, the terminal 100 supplies the constructed list of specific information, to the server 500.

Then, during a step 505, the server 500 analyses the list of specific information found, that it received from the terminal 100, determines an advertisement (or several advertisements, if applicable) adapted to said list and supplies them to the terminal 100. In this way, the advertising supplied is highly targeted.

Then, during a step 506, the terminal 100 displays the advertisement received from the server 500 (or the advertisements received, if applicable).

Then, during a step 307, the terminal runs the instructions following the script code “include” in the delivered content 202, particularly the instructions present at the end of the body 203 and in the content footer 204.

According to a first alternative described with respect to FIG. 2, the active code is not placed in the body 203 of the content 200 but in its header 202, or in the footer 204. It may also be placed outside the HTML fields while remaining in the content 200 supplied to the terminal 100.

Placing the active code at the end of the body 203, in the HTML code footer 204 or after said footer 204, while remaining in the content 200, is of particular interest since, in this case, the entire downloaded page is displayed when the semantic search on said page is performed during the step 503.

According to another alternative, the semantic search operation 503 is used for applications to insert information (such as links to Internet sites, annotations, etc., in particular) relating to the result of the semantic search (i.e., for example, in the same area as one or more items in the specific information list, from the semantic search, or a relating or resulting area), said information not being necessarily related to advertising.

According to an alternative of the step 503, the semantic search is performed not only on page data displayed on the screen but also on all the downloaded content 200. The result of the semantic search can then be used by numerous types of applications, particularly censoring application (as described with respect to FIG. 3), applications modifying data presentation, and/or application to insert additional data.

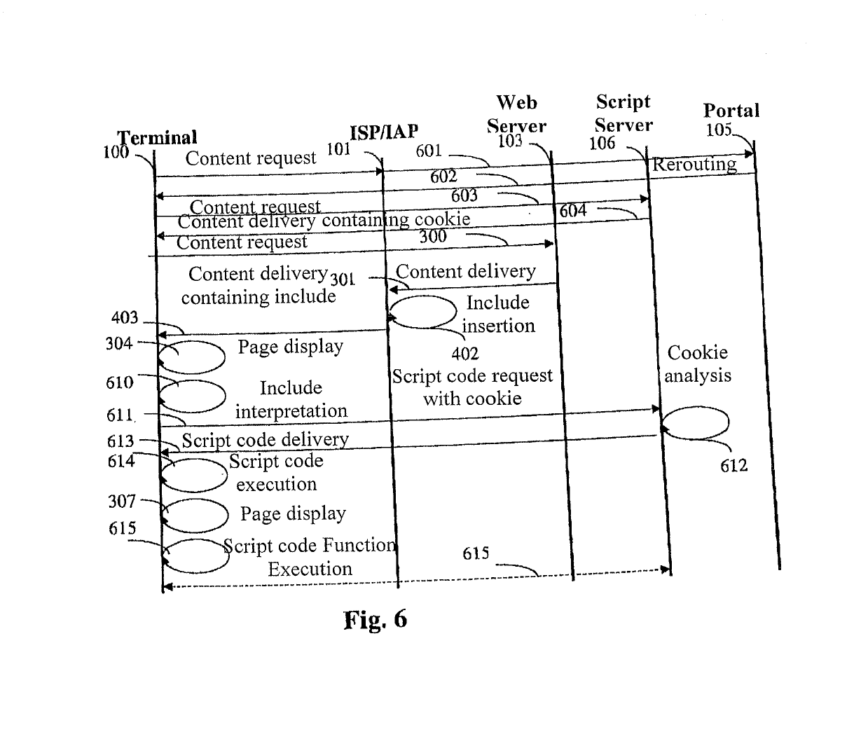

FIG. 6 shows a communication protocol for a permanent Internet service provision type application.

During a content request step 601, the terminal requests a content from a portal type server 105.

Then, during a rerouting step 602, the server 105 gives the terminal 100 a URL address which the terminal 100 is to access.

Then, during a step 603, the terminal 100 accesses the URL address of the script server 106, specified by the server 105 and requests a content.

Following this, during a step 604, after a user profile definition step for the terminal 100 (the user of the terminal 100 having, for example, answered a questionnaire or filled in a form online), the server 106 delivers to the terminal 100 a content which contains a customised cookie, specific to the user of the terminal 100 and according to the user profile. In this way, it will be possible to have, for example, a cookie specifying the user name:

“ClientName=firstname.lastname” and more generally a profile specifying the user's preferences. During said step 604, after the delivery of the customised cookie, the terminal 100 stores in memory said cookie which is attached to the server 106, and may accompany each subsequent content request to the server 106 by the terminal 100.

This is followed by steps 300, 301, 402, 403 and 304, identical to the first steps of the protocol described with respect to FIG. 4, except that, during the script code “include” insertion step 402, the access provider 101 inserts a specific script code “include”, the final purpose of which is to provide a script code accounting for a delivered cookie, linked to the script server 106. Said steps being similar to the first steps in FIG. 4, they bear the same reference numbers and will not be described further.

Following the page start display step 304, during an interpretation step 610 of the script code “include” received, the terminal 100 interprets said “include” by decoding the instructions present in the script code “include”.

Then, during a step 611, the terminal 100 requests a content from the script server 106, by sending the cookie present on the terminal 100, linked to the server 106 and delivered during the step 604.

Then, during a step 612, the server 106 analyses the cookie received in order to deliver a final script code adapted to the needs of the user of the terminal 100.

In this way, if the cookie contains a user profile identifying the user and/or indicating for example their preferences in an encoded format, the server 106 generates a script code adapted to the user profile and customised.

Following this, during a step 613, the server 106 delivers to the terminal 100 a script code as determined by the server 106 during the step 612. The terminal 100 then stores the script code in memory.

Then, during a step 614, the terminal 100 runs the script code received which consists of associating a function present in the script with an event in the event manager present in the terminal's browser (such as for example, pressing a key on the keyboard, an action on the mouse associated with the terminal, such as a right-click (or, in other words, pressing the right button on the mouse), a combined action on the keyboard and the mouse or a browsing event).

In this way, for example, a display function for a menu particularly enabling access to services offered by the script server 106 may be associated with a right-click on the mouse. In this way, one or more services which become accessible simply with a right-click on the mouse have been declared.

These services particularly consist of:

simplified access services to information other than that contained in the content 200;

simplified access services to search engines;

simplified access services to advanced functions of a browser comprised in the terminal 100;

external event monitoring services; and

simplified access to at least one service available manually on the Internet and which requires at least one data input operation.

Then, during a step 307, the terminal runs the instructions following the script code “include” in the delivered content 202, particularly the instructions present at the end of the body 203 and in the content footer 204.

During or following the step 307, during a step 615 whenever the user of the terminal 100 right-clicks on the mouse under the browser application, a menu display script code function will be run, the event manager of the browser having associated said function with the right-click action. The user can then select an item on the displayed menu enabling them in particular to access a service offered by the script server 106.

In an alternative of the step 615, the user can then select an icon which will have been previously declared and displayed by the active code, enabling them in particular to access a service offered by the script server 106. Note that the browser event manager enables access to the service by associating said access function with the icon selection action.

In an alternative, the script delivered by the script server 106 during the step 613 comprises a function (such as menu display, for example) which is run without it being necessary to link an event.

The embodiments described are not intended to reduce the scope of the invention. As a result, numerous modifications may be made without leaving the scope of the invention; in particular, it is possible to envisage the inserted active code not being a Javascript code or a script code “include” interpreted by a browser.

In this way, the invention also relates to the case where the active code is:

a script (not necessarily Javascript);

a browser object;

a browser object operation;

an applet;

an applet operation; and

a macro-instruction.

The invention also relates to the case where the active code comprises at least one code type from the above-mentioned codes including, in particular, scripts, script code includes, browser objects, applets, browser object or applet operations and macro-instructions.

ActiveX® codes are generally inserted in a content, while being delimited by <object> and </object> tags.

Applet codes are generally inserted in a content, while being delimited by <applet> and </applet> tags.

In addition, it is possible to produce any variant in the infrastructure of the networks described in the capacity of those skilled in the art. Some network components described may for example be combined. It is in particular possible to combine the content and script server equipment. The content provider will also be able to supply scripts directly in response to a request following the interpretation of a script code “include” by a terminal.

In addition, according to the invention, the active code is inserted by any component belonging to the infrastructure of a communication network, particularly the Internet; in this way, said component may be not only an Internet service or access provider, but also, for example an Internet site host server (such as the component 102 described with respect to FIG. 1), a router, a switch, a gateway or a proxy.

In addition, the invention is not restricted to the case where a single script code is inserted on the fly in a content, but applies to the case where several script codes are inserted on the fly in a content, it being possible for said script codes to be of the same type or not, be dependent or not. (In addition, ActiveX® or applet codes generally require a script code to be used).

In this way, it is possible, for example, to insert two active codes in a content enabling the use of an Internet meeting type application, one of the codes being of the ActiveX type

(<Object ID=Netmeeting CLASSID “CLSID :identifier”> <PARAM NAME=““MODE” VALUE=“telephone”>)

and the other script code type making the call

(<script language=“javascript1.2”> Netmeeting.CallTo(“callto:0171000803+gateway=195.115.183.1+type=phone”); </script>).

In addition, the invention is not restricted to the case where the active code inserted on the fly is generated as a function of the data of the downloaded page, but it applies to the case where the active code inserted on the fly is generated as a function of any criterion such as in particular, the user(s) of the terminal 100, the terminal 100 itself, the site supplying the data, the component of the network architecture inserting the active code on the fly, the browser used by the terminal 100. During the inserted script code generation operation, one or more criteria may be taken into account, particularly the identity of the user(s) of the terminal 100, their preferences, the address and/or domain name of the remote site having supplied the downloaded data on the terminal 100, the address of the downloaded page, the browser type and/or version used by the terninal, the type and/or version of the terninal 100, the transfer protocol used to download the downloaded page 200, the component of the network architecture inserting the active code on the fly.

1. Consultation optimisation method for a data page consulted on at least one terminal by at least one user, said page being downloaded from a first remote site via a communication network, characterised
in that it comprises an on-the-fly insertion step of at least one active code in said page by at least one component of the architecture of said network,
in that the area of said page wherein said active code is inserted is determined according to the type of action generated by said active code,and
in that said active code inserted on the fly is an intermediate invocation active code, which, when run by said terminal, enables said terminal, during an invocation step, to invoke a final active code provider, so that the terminal receives from said provider a specific final active code enabling the running of an algorithm on said terminal.

2. Optimisation method according to claim 1, characterised in that said communication network is an Internet type network.

3. Optimisation method according to claim 1, characterised in that said at least one component of the architecture of said network belongs to the group comprising: Internet site host servers, access provider equipment, service provider equipment, routers, switches, gateways, and proxies.

4. Optimisation method according to claim 1, characterised in that said active code inserted on the fly is a final active code used to run an algorithm on said terminal.

5. Optimisation method according to claim 1, characterised in that, during said invocation of the final active code provider by said terminal, the terminal also provides at least one cookie.

6. Optimisation method according to claim 5, characterised in that it also comprises at least one step prior to said on-the-fly insertion step and belonging to the group comprising:
steps consisting of rerouting an access of said terminal to the final active code provider,
steps consisting of defining a profile of the user of said terminal,
steps consisting of generating said at least one cookie as a function of the user profile of said terminal,
steps consisting of provision of said at least one cookie by the final active code provider to said terminal, and
steps consisting of storage of said at least one cookie by said terminal.

7. Optimisation method according to claim 5, characterised in that said at least one cookie is used for identification purposes.

8. Optimisation method according to claim 5, characterised in that said final active code provider takes into account of the content of said at least one cookie to generate the specific final active code.

9. Optimisation method according to claim 1, characterised in said active code belongs to the group comprising:
script codes interpreted by a browser,
script code “includes” interpreted by a browser,
browser objects,
browser object operations,
applets,
applet operations, and
macro-instructions.

10. Optimisation method according to claim 1, characterised in that said active code inserted in said page is loaded and/or interpreted and/or run by said terminal before, during and/or after the display of said page on said terminal.

11. Optimisation method according to claim 1, characterised in that said active code is run in a browser comprised in said terminal.

12. Optimisation method according to claim 1, characterised in that said active code is generated specifically as a function of at least criterion specific to a component belonging to the group comprising:
said at least one user of said terminal,
said terminal,
said first remote site,
said page,
the components of the architecture of said network, and
the browser used by said terminal.

13. Optimisation method according to claim 12, characterised in that said at least one criterion belongs to the group comprising:
the identity of said at least one user of said terminal,
the preferences of said at least one user of said terminal,
the address and/or domain name of said first remote site,
the address of said downloaded page,
the browser type and/or version used by said terminal,
the type and/or version of said terminal,
the transfer protocol used to download said downloaded page, and
the Internet access provider (IAP) or service provider (ISP) enabling said terminal to access said first remote site.

14. Optimisation method according to claim 1, characterised in that it is used for at least one application belonging to the group:
insertion, in said page, of information, particularly advertising,
insertion, in said page, of information, particularly advertising, as a function of the content of said page,
insertion, in said page, of information relating to events handled by a second remote site connected to said network,
insertion, in said page, of information relating to data available on a portal in relation to the content of said page,
provision to the user, via said page, of at least one service provided by at least one third remote site connected to said network,
archival of information related to the activity on said network of the user of said terminal,
modification of the presentation of said data,
censoring of at least one data item in said data, and
invocation of at least one second active code.

15. Optimisation method according to claim 14, characterised in that it is used for at least one application for the insertion in the page of additional information, and in that the active code implements the following operations:
search for at least one specific information item in said page,
creation of a list of specific information found in said page,
creation of an additional information insertion field in said page
provision of said list of specific information to an information provider connected to said network, and
filling of said additional information insertion field with the data provided by said information provider in response to said specific information list provision operation.

16. Optimisation method according to claim 15, characterised in that said additional information belongs to the group comprising:
advertising information,
annotations,
additional links to remote sites discussing the same subject as said downloaded page,
additional links to remote sites discussing subjects related to the subject of said downloaded page,
alternative key-words,
notes assigned to said first remote site, and
indexing tables for the components of said downloaded page.

17. Optimisation method according to claim 14, characterised in that it is used for at least one application modifying the presentation of said data; and in that said active code implements the following operations:
search for at least one specific information item in said page,
creation of a list of specific information found in said page,
provision of said list of specific information to an information provider connected to said network, and
presentation of at least part of said downloaded data according to a format defined by the information provider in response to said specific information list provision operation.

18. Optimisation method according to claim 14, characterised in that it is used for at least one application to censor at least one data item in said data, and in that said active code implements the following operations:
search for at least one specific information item in said page,
creation of a list of specific information found in said page,
provision of said list of specific information to an information provider connected to said network, and
censoring of at least part of said downloaded data according to at least one criterion defined by said information provider in response to said specific information list provision operation.

19. Optimisation method according to claim 14, characterised in that it is used for at least one application to invoke at least one second active code, and in that said active code implements the following operations:
search for at least one specific information item in said page,
creation of a list of specific information found in said page,
provision of said list of specific information to a provider of additional information connected to said network, and
invocation of at least one second active code according to at least one criterion defined by said information provider in response to said specific information list provision operation.

20. Optimisation method according to claim 14, characterised in that said at least one specific information item belongs to the group of information comprising:
key-words,
link addresses,
addresses of added items in said downloaded page, and
creation information on said downloaded page.

21. Optimisation method according to claim 14, characterised in that said at least one specific information item is updated according to a predetermined criterion.

22. Optimisation method according to claim 21 characterised in that said predetermined criterion belongs to a group of criteria comprising:
the identity of said at least one user of said terminal,
the preferences of said at least one user of said terminal,
the address and/or domain name of said first remote site,
the address of said downloaded page,
the browser type and/or version used by said terminal,
the type and/or version of said terminal,
the transfer protocol used to download said downloaded page, and
the Internet access provider enabling said terminal to access said first remote site.

23. Optimisation method according to claim 1, characterised in that it is used for at least one application for permanent provision to the user, via said page, of at least one service provided by at least one fourth remote site connected to said network, and in that said active code, when it is run by the terminal, declares said at least one service in said page.

24. Optimisation method according to claim 23, characterised in that said code enables the implementation by the terminal of an access menu to said at least one service.

25. Optimisation method according to claim 23, characterised in that said at least one service belongs to the group comprising:
simplified access services to information other than that contained in said page,
simplified access services to search engines,
simplified access services to advanced functions of a browser comprised in the terminal,
external event monitoring services, and
simplified access to at least one service available manually on the Internet and which requires at least one data input operation.

26. Optimisation method according to claim 23, characterised in that said at least one service is attached to at least one event belonging to the group comprising:
actions on a man-machine interface, and
browsing events.

27. Optimisation method according to claim 23, characterised in that said at least one service is attached to at least one mark-up language component.

28. Optimisation method according to claim 1, characterised in that said on-the-fly insertion step is systematic or selective.

29. Optimisation method according to claim 1, characterised in that the execution of said active code is interrupted when the user requests the display of a new data page.

30. Optimisation method according to claim 1, characterised in that, when said data page is composed of at least two sub-pages, said active code is included in each said sub-page.

31. System enabling optimisation of consultation of a data page consulted on at least one terminal by at least one user, said page being downloaded from a first remote site via a communication network, characterised
in that at least one component of the architecture of said network comprises means to insert at least one active code on the fly in an area of said page determined according to the type of action generated by said active code, and
in that said active code inserted on the fly is an intermediate invocation active code, which, when run by said terminal, enables said terminal, during an invocation step, to invoke a final active code provider, so that the terminal receives from said provider a specific final active code enabling the running of an algorithm on said terminal.

32. Device for the optimisation of consultation of a data page consulted on at least one terminal by at least one user, said page being downloaded from a first remote site via a communication network to which said device belongs,
characterised in that it comprises means to insert at least one active code on the fly in said page, in an area of said page determined according to the type of action generated by said active code,
and in that said active code inserted on the fly is an intermediate invocation active code, which, when run by said terminal, enables said terminal, during an invocation step, to invoke a final active code provider, so that the terminal receives from said provider a specific final active code enabling the running of an algorithm on said terminal.

33. Optimisation device according to claim 32, characterised in that it belongs to the group comprising:
Internet site host servers,
access provider equipment (IAP)
service provider equipment (ISP),
routers,
switches,
gateways, and
proxies.
